(19) United States
(12) Patent Application Publication
(10) Pub. No.: US 2025/0305780 A1
(43) Pub. Date: Oct. 2, 2025

(54) SYSTEM AND METHOD FOR PREVENTING SEDIMENT FORMATION IN TANK DURING HEAT EXTRACTION FROM WASTEWATER

(71) Applicant: Celsium Group i Umeå AB, LIDINGÖ (SE)

(72) Inventors: LENNART OLOFSSON, Umeå (SE); Anders MIKAELSSON, Vilhelmina (SE)

(21) Appl. No.: 18/864,226

(22) PCT Filed: May 10, 2023
(86) PCT No.: PCT/SE2023/050454

§ 371 Date: Nov. 8, 2024

(30) Foreign Application Priority Data
May 19, 2022 (SE) 2250603-4

(51) Int. Cl. F28F 19/00; F28D 21/00

(52) U.S. Cl. CPC F28F 19/00; F28D 21/0012

(57) ABSTRACT

The invention relates to a system and a method for preventing sediment formation in at least one tank during heat extraction of thermal energy from wastewater from properties, which the system comprises; at least one pump pit, a wastewater inlet, a pump, a pump pit outlet and a drain opening, at least one buffer tank, and at least one collector tank 1, a heat exchanger, in the collector tank, a heat pump, and an accumulator for accumulating heat. To avoid sediment formation, at least one of the pump pit, the buffer tank or the collector tank comprises at least one ejector for compressed air arranged therein, which ejector is connected to a compressed air device for controlling the supply of compressed air to at least one of the at least one pump pit, the buffer tank or the collector tank through the at least one ejector.

### TECHNICAL AREA

The present patent application relates to a system for preventing sediment formation in a tank during heat extraction from wastewater, and a method for controlling such a system.

### BACKGROUND

Heat extraction from spillage water (wastewater) from properties is an environmentally friendly and efficient way to save energy for said properties. All wastewater that is generated within a property, such as shower water, dish water, toilet flushes, washing water and so on, is directed down a drain which is carried on to a heat extraction system via sewer lines, instead of just being flushed away from the property via a sewage network to a treatment plant or the like. Wastewater usually has a slightly higher heat content, which can be extracted by letting the wastewater pass through a heat exchanger in a heat extraction system. The thermal energy thus extracted can then be returned to the heating system property.

However, handling wastewater involves certain difficulties because the wastewater is usually not clean but can contain considerable amounts of impurities in the form of fluids and/or solid particulate material. A system that handles wastewater should ideally be equipped to handle both so-called greywater; i.e. wastewater from baths, dishes and laundry; as blackwater, i.e. wastewater from toilets which may contain solid objects such as food residues, toilet paper, faeces etc. Therefore, it is desirable that a heat extraction system is adapted to handle this. Special sewage pumps are known for this purpose, for example cutting pumps or so-called churning pumps capable of grinding and comminuting solids to produce a slurry mixture that may be pumped through a thermal energy extraction system. However, sludge tends to settle to the bottom of the various tanks through which the sludge passes, particularly when the system is stationary and not in active use. Such sediment can then clump together and form larger “cakes” of grease and dirt, which not only limit the system's efficiency, but in the worst-case risk putting the entire system out of order.

### SUMMARY OF THE INVENTION

Despite existing known technology, there is a need to develop an improved heat extraction system for wastewater, which system is more efficient and more reliable than hitherto known heat extraction systems. There is further a need for such a system in which sedimentation in the tanks therein is prevented. Furthermore, there is also a need for a method for how such a system should be controlled.

A first object of the present invention is thus to stop, prevent and/or minimize problems with known technology, and provide an improved heat extraction system for wastewater, which system is more efficient and more reliable than previously known systems. A further object of the invention is to provide a system that prevents sedimentation in tanks for heat extraction of wastewater from a property. A further object is to provide a method for controlling such a system.

According to a first aspect, a system for heat extraction of thermal energy from wastewater from properties is provided. The system comprises: at least one pump pit, comprising a pump pit inlet for the introduction of wastewater, a pump pit outlet, a pump for pumping wastewater from the pump pit to the pump pit outlet, and a drain opening (17) for discharging wastewater.

The system further comprises at least one buffer tank arranged for storage of pumped wastewater, at least one collector tank for collecting wastewater, and at least one heat exchanger arranged at the at least one collector tank for moving heat from said collector tank to a heat pump in the system. Furthermore, at least one of the pump pit, the buffer tank or the collector tank comprises at least one ejector for compressed air arranged therein. The ejector is connected to a compressed air device for controlling supply of compressed air to at least one of the at least one pump pit (10), the buffer tank (20) or the collector tank (30), through the at least one ejector.

This has the advantage that compressed air can be supplied to each contained volume of the pump pit or the tanks that have such an ejector arranged therein. As the system intends to use heat from wastewater from a property, said water is not to be considered clean water. Wastewater can contain paper, food scraps, faeces and similar solid matter, which matter can easily sink to the bottom of the various tanks and give rise to sedimentation therein. The compressed air can therefore be supplied to each space with an ejector arranged therein in order to prevent solid particles from sinking to the bottom by means of turbulence, obtained by the supplied compressed air. This reduces the risk of sedimentation on the bottom of the tank. With less sediment, the volumes of the tanks are maintained more intact, and the risk of the sediment compacting into a large lump/cake is reduced. Such a lump/cake otherwise poses a risk of blocking the flow of wastewater in pipes, valves or similar components. By introducing at least one ejector for compressed air supply, the entire system runs both more efficiently and with less risk of breakdown. In addition, the effect that can be extracted from the wastewater increases as the maximum amount of wastewater can be taken in and used by the system.

According to one aspect, the pump pit comprises at least one ejector for compressed air arranged therein. It has the advantage that sedimentation in the pump pit can be reduced.

According to one aspect, the ejector is arranged at a distance from a bottom of the pump pit, and is directed so that compressed air from the ejector is supplied to the space in a direction away from said bottom. This has the advantage that a certain amount of sedimentation can be allowed on the bottom of the tank, whereby such sediment can still be taken into some pump models, such as a grinder pump, which can grind solid objects so that a larger amount of spillage can be taken care of in the process. Furthermore, it can also be advantageous to have a certain section in the pump pit, in this case a section at the bottom where the pump is advantageously located, which is free from added air, as a pump intended for liquid often cannot get air into it without to risk a breakdown.

According to one aspect, the buffer tank comprises at least one ejector for compressed air arranged therein. It has the advantage that sedimentation in said buffer tank can be reduced.

According to one aspect, the ejector is arranged at a bottom of the at least one buffer tank, and is directed so that compressed air from the at least one ejector is supplied to the buffer tank in a direction that corresponds to a flow direction of incoming wastewater. It has the advantage that compressed air can be supplied at a position close to the introduction of wastewater into the buffer tank, whereby the risk of sedimentation is reduced as the compressed air strikes a position in the buffer tank where sedimentation easily occurs. Furthermore, another advantage achieved is that the risk of the opening of the ejector being blocked by incoming solid particles is minimized when said opening faces away from the flow direction of an inflow into the tank. Compressed air can be added when water from the buffer tank is needed in the collector tank, whereby as much as possible can be emptied from the buffer tank into the collector tank during such an emptying procedure.

According to one aspect, the at least one collector tank comprises at least one ejector for compressed air arranged therein. It has the advantage that sedimentation in the collector tank can be reduced.

According to one aspect, the ejector is arranged at a bottom of the collector tank, and is directed so that compressed air from the ejector is supplied to the buffer tank in a direction corresponding to a flow direction of incoming wastewater. It has the advantage that compressed air can be supplied at a position close to the introduction of wastewater into the collector tank, whereby the risk of sedimentation is reduced when the compressed air strikes a position in the collector tank where sedimentation easily occurs. Furthermore, another advantage achieved is that the risk of the opening of the ejector being blocked by incoming solid particles is minimized when said opening faces away from the flow direction of an inflow into the tank. Compressed air can be added when water from the collector tank needs to be emptied, in order to be able to empty the tank as much as possible with as large a discharge of solid matter as possible during such an emptying procedure.

According to one aspect, each ejector is an open end of a tube. It has the advantage that compressed air can be supplied to the system through a very simple and cost-effective solution.

According to one aspect, the tanks of the system are made of plastic material, for example of polyethylene, which can be designed in areas with profiled reinforcement parts in the shell of the tank.

The choice of plastic has the advantage that the tanks can be manufactured cost-effectively, and that it is advantageous to avoid, for example, metal for tanks that will house wastewater, as metal can easily corrode from wastewater that contains unfavourable additives therein.

According to one aspect, the compressed air device comprises a control system, which control system controls the compressed air device automatically based on operating parameters of the system, and/or manually by means of a user interface comprised in the control system. It has the advantage that the compressed air can be supplied to the system in the most efficient way possible during operation, and also controlled manually when specific maneuvers are desired to be carried out, which may be relevant during the procedure such as emptying the system in connection with service or the like.

According to one aspect, the compressed air device is configured to supply compressed air to the system in the form of impulses of a flow of said compressed air. It has the advantage that considerable turbulence can be produced in the system for a short period of time. Furthermore, the amount of compressed air supplied to the system can be controlled and reduced by supplying the compressed air with short but distinct impulses, whereby a required pressure front and turbulence is obtained with a smaller amount of compressed air.

According to a second aspect, a method is provided for preventing sediment formation in at least one tank of the system during heat extraction from wastewater, by means of a system according to the first aspect. The method comprises steps: a) providing compressed air to at least one tank by means of an ejector. It has the advantage that a method that can minimize the risk of sediment formation is achieved. When the formation of sediment is minimized, the risk of a stoppage in the system is also reduced, or a worsened efficiency thereof due to a reduction of usable water within the system.

According to one aspect, step a) of the method comprises the sub-step: a1) providing compressed air in the form of intermittent impulses that are repeated with a predetermined frequency. It has the advantage that considerable turbulence can be produced in the system for a short period of time. Furthermore, the amount of compressed air provided to the system can be controlled and reduced by supplying the compressed air with short but distinct impulses, whereby a required pressure front and turbulence is obtained with a smaller amount of compressed air.

According to one aspect, step a) of the method comprises the sub-step: a2) providing compressed air in the form of a continuous flow. It has the advantage that sedimentation is reduced by means of a constant turbulence of the wastewater, which turbulence is obtained by means of the constant supply of compressed air.

According to one aspect, the method further comprises a step: b) switching between sub-step a1) and sub-step a2) based on predetermined limits of operating parameters within the system. It has the advantage that the system can be provided with a certain constant turbulence from sub-step a2), in order to periodically provide another significantly different turbulence when transitioning to sub-step a1). This can be controlled to avoid sedimentation and clogging of the system in the most efficient way possible, whereby the various sub-stages can be run based on the current operating status and liquid levels in the tanks.

### FIGURE DESCRIPTION

Guided by the attached drawings, the invention is shown in more detail, in which:

FIG. 1 shows a schematic representation of a system for heat extraction from wastewater from a property,

FIG. 2 shows a schematic flow chart for a system for heat extraction from wastewater which system further comprises an ejector in a tank to prevent sediment formation,

FIG. 3 shows a schematic sketch of a pump pit including an ejector for providing compressed air therein,

FIG. 4 shows a schematic sketch of a buffer tank including an ejector for providing compressed air therein,

FIG. 5 shows a schematic sketch of a collector tank including an ejector for supplying compressed air therein,

FIG. 6 shows a schematic sketch of a user interface for a control system comprised in the inventive system, and

FIG. 7 schematically shows a flow chart for a method for extracting heat from wastewater from a property, the method comprising providing compressed air to the system.

### DESCRIPTION OF EMBODIMENTS

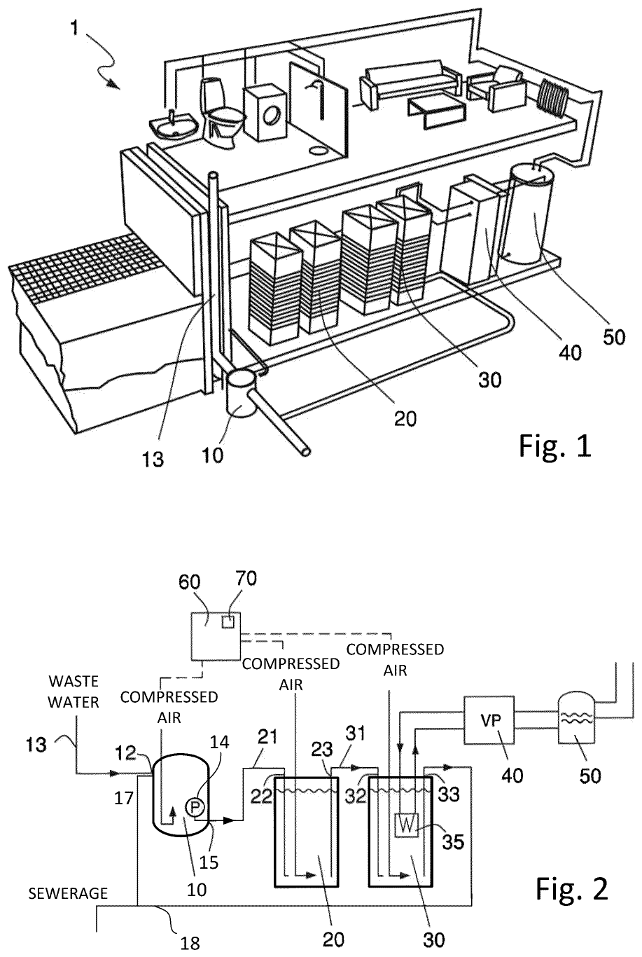

FIG. 1 shows a schematic representation of a system 1 for heat extraction from wastewater from a property 2 and in which system a pump pit is denoted by 10, a buffer tank by 20, a collector tank by 30, a heat pump by 40, an accumulator tank by 50, a compressed air device with 60 and a control system with 70.

In a broad sense, the pump pit can also be described as a tank, and each of the pump pit, the buffer tank and the collector tank are to be considered as spaces for housing fluids and solid matter. For increased understanding, the terms tanks and spaces are thus to be regarded as synonymous descriptions within the wording of the description.

The pump pit 10 of the system 1 comprises a wastewater inlet 12 for leading wastewater into the pump pit via a supply line 13 from the property 2. A pump 14 is further arranged in the tank 11, which pump is configured to pump wastewater from the pump pit 10 to a pump pit outlet 15. The pump pit 10 further comprises drain opening 17 with a drain line 18 which can lead wastewater out of the pump pit's tank 11 whereby the water level in the tank 11 can be ensured by so-called overflow.

The buffer tank 20 of the system is arranged in fluid communication with the first pump pit outlet 14 of the pump pit 10 via a buffer tank line 21 and a buffer tank inlet 22 of the buffer tank 20. The buffer tank 20 further comprises a buffer tank outlet 23 and is intended as a unit for storing pumped wastewater.

The collector tank 30 of the system 1 is arranged in fluid communication with the buffer tank outlet 23 of the buffer tank 20 via a collector tank line 31 and a collector tank inlet 32 of the collector tank 30, which collector tank is arranged for collecting wastewater and taking its heat content. The collector tank 30 has a collector tank outlet 33 with which the collector tank is connected to a drain line 18 for the removal of wastewater that has given off its heat content. Furthermore, the system 1 comprises a heat exchanger 35 that is arranged in the collector tank 30 for heat transfer of wastewater in the collector tank 30 to the heat pump 40 whereby heat can be stored in the accumulator tank 50.

The system 1 works in principle so that wastewater enters via the supply line 13 from a drain line at the property 2, whereby the wastewater is led into the pump pit 10, whereby the pump 14 is arranged to pump wastewater from the pump pit 10 to the buffer tank 20 via the buffer tank line 21. The pump 14 is of the type that can handle a mixture of water and solid material, for example a so-called grinder pump. A grinder pump can grind solid particles and pump the resulting sludge to the buffer tank. It should also be mentioned that the number of the various housing spaces, such as the pump pit 10, the buffer tank 20 and the collector tank 30, can be varied within a system 1. How large a system 1 is depends at least in part on the type of building the system 1 is connected to, whereby the housing spaces can be varied in number and/or size in order to best adapt to parameters that affect system 1 and its operation.

What is described above essentially constitutes known technology.

The inventive system is shown in more detail in FIG. 2-4 and in which at least one of the respective tanks comprised in any of the pump pit 10, the buffer tank 20 or the collector tank 30 comprises an ejector 10:1, 20:1, 30:1 that is connected to a source of compressed air not shown in detail. Each ejector 10:1, 20:1, 30:1 is connected to a computer-based compressed air control device 60 for controlling the supply of compressed air from said source to the ejector. One or every tank shown in FIG. 2-4 is preferably made of plastic material, for example polyethylene, which can be designed in areas with profiled reinforcement parts in the outer shell of the tank, whereby corrosion attack or such damage functions as metal vessels can be exposed to are avoided.

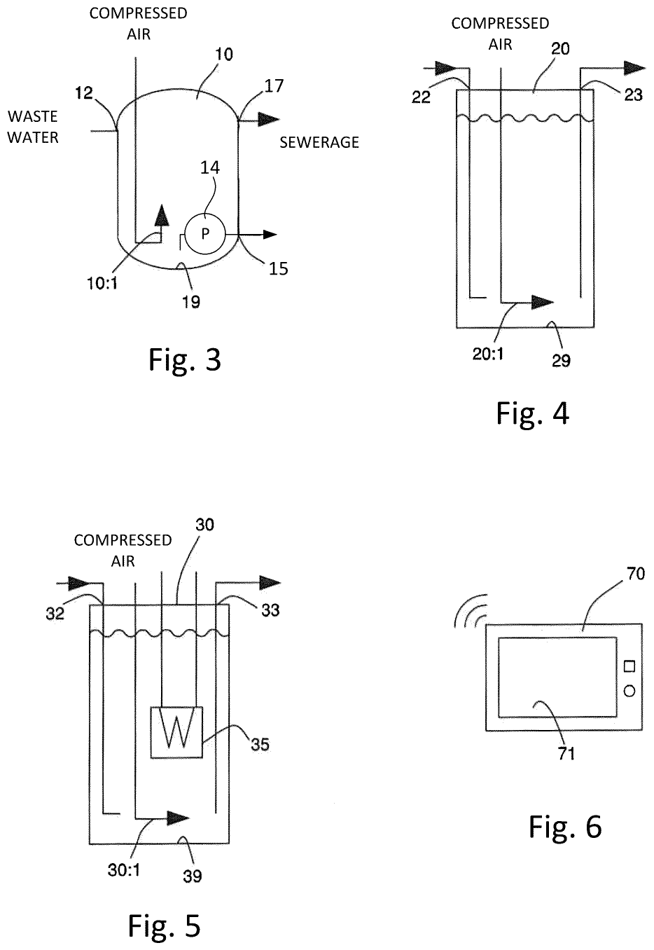

Referring to FIG. 3, a pump pit 10 with an ejector 10:1 for supplying compressed air therein is shown in more detail. The pump pit 10 comprises a tank of the type described above. The 10:1 ejector is herein to be perceived as an open end of a pipe, through which pipe compressed air can flow into the tank. An ejector 10:1 in the form of a nozzle or a spray nozzle can be mounted in the open end of the pipe to obtain a greater dispersion of the compressed air flowing out of the pump pit 10.

The ejector 10:1 is arranged at a distance from a bottom 19 of the pump pit 10 and is directed so that compressed air from that ejector 10:1 is provided to the pump pit 10 in a direction away from said bottom 19, essentially in a vertically upward direction. Through such a placement, it is ensured that air bubbles from the compressed air end up above an intake area for the pump 14. This ensures the function of the pump 14, whereby cavitation and damage to the liquid pump can be avoided. The compressed air that is supplied will thus function as a stirring function for collected wastewater within the tank 11. It should be understood that the pressure front of the compressed air will create an upwardly directed force that can break up “fat cakes” that may accumulate on a surface of the wastewater; and also cause turbulence within the tank which makes it more difficult for solid particles to sink to the bottom and settle there. Because the ejector 10:1 is positioned at a distance from a bottom 19 of the pump pit 10, and is directed away from said bottom 19, some sedimentation can take place on the bottom below the ejector 10:1. This sedimentation will then, however, be sucked in by the pump 14, which finely distributes these particles so that clumping of said particles can be avoided.

With reference to FIG. 4, a buffer tank 20 is shown comprising an ejector 20:1 for supplying compressed air therein. The wastewater that is stored in the buffer tank 20 can consist of both clean wastewater and a thicker sludge, depending on the purity of the wastewater from the property, and how much sediment and particles/objects have been taken in via the pump 14 into the pump pit 10. The ejector 20:1 is here arranged at a bottom 29 of the buffer tank 20, and is directed so that compressed air from the ejector 20:1 is supplied to the buffer tank 20 in a direction that corresponds to a flow direction of incoming wastewater, which should be realized if FIG. 3 is studied more closely. The ejector 20:1 should also be considered here as an open end of a pipe, through which pipe compressed air flows into the buffer tank. Modifications to the ejector 20:1 can be made as indicated for the tank of the pump pit 10 with reference to the description for FIG. 3. The ejector 20:1 is in a direction so that the flow of wastewater/sludge and the flow of compressed air substantially coincide. This creates a turbulence in direct connection to a position where the introduction of wastewater takes place. The compressed air creates a flow of air and water that moves upwards, which flow pulls particles up from the bottom of the buffer tank and sedimentation is avoided. Similar to the tank according to FIG. 3, a supply of compressed air contributes to both avoiding sedimentation by means of turbulence, and to breaking up any lumps of solid material. The buffer tank further comprises at least one outlet, which is in fluid communication with the collector tank. This outlet is configured to transfer wastewater/sludge to the collector tank. Such a transfer occurs when the water level in the collector tank becomes too low, whereby the collected water/sludge in the buffer tank can be transferred to the collector tank to maintain the system's heat extraction function.

As described above, transfer of water/sludge from the buffer tank 20 to the collector tank 30 can be initiated automatically by means of a control system as well as periodically controlled in which way pressurized air is led from said pressure source to each ejector 10:1, 20:1, 30:1. The control system comprises a user interface by means of which an operator can graphically or in another suitable way control and check the various functions of the control system.

With reference to FIG. 5, a collector tank 30 comprising an ejector 30:1 for supplying compressed air therein is shown in more detail. Analogous to the buffer tank 20 in FIG. 4, the ejector 30:1 in the collector tank 30 is arranged at a bottom 39 of the collector tank, and is directed in such a way that compressed air which is led out from the ejector 30:1 is supplied to the buffer tank in a direction which essentially corresponds to a direction of flow of the wastewater in the collector tank 30. This positioning gives in principle the same technical function and advantages to it as described above with reference to the buffer tank 20. Sediment formation is minimized and solid objects are broken, and thanks to the placement obtains a flow upwards in the collector tank. This flow is also favourable for the heat extraction itself. wherein said upward flow of wastewater/sludge increases movement within the tank so that heat from wastewater/sludge can be more efficiently transferred to a heat-carrying medium at the heat exchanger 35.

Referring to FIG. 6, a schematic diagram of a computer-based user interface 51 for a control system 50 of the system is shown. The interface 51 can be an external portable screen/pad or the like, and is wirelessly connected to a control system for a compressed air device 60 that supplies each existing ejector 30:1, 30:2, 30:3 with compressed air. The compressed air device 60 is controlled by the control system automatically based on operating parameters of the system, and/or manually by means of the user interface comprised therein. Each tank 10, 20, 30 comprised in the system can be equipped with sensors for monitoring the amount of liquid, flows and possible operational disturbances and so on. By, for example, monitoring the amount of liquid in the collector tank 30, the control system can automatically transfer wastewater/sludge from the buffer tank when the amount of liquid in the collector tank falls below a predetermined level, whereby the heat extraction is maintained at a good level. Furthermore, a user of the system can by means of the user interface 51 monitor acquired power, the current operating status of the system and perform direct commands such as for example emptying the entire system and disconnecting it from the sewage system if desired. The control system can also control how compressed air is supplied via existing ejectors 10:1, 20:1, 30:1.

The compressed air device 60 can be configured to supply compressed air to the system in the form of pulses of a flow of said compressed air. These compressed air impulses, or “shocks” of compressed air can be varied in frequency, amplitude and length. Preferably, the compressed air pulses in 1-5 shocks of approx. 0-1 second with a pause of approx. 0.1-3 seconds between each shock. Advantageously, the compressed air can pulse the compressed air with three shocks of 0.5 seconds with a 1-second interval between each shock. This can then be chosen to be run only when movement of wastewater takes place to and/or between the tanks 10, 20, 30 comprised in the system or to be run at regular intervals even if the system is otherwise at rest.

It is also possible to run the compressed air device 60 in alternative ways, such as having a low constant flow of compressed air supplied to the system at a higher frequency up to continuously, to switch over to a pulsed one under specific operating conditions and/or input from a user via the user interface supply in order to take advantage of stronger pressure fronts from the pulsed compressed air.

As should be obvious, a system for preventing sediment formation in at least one tank 10, 20, 30 of a system for heat extraction from wastewater may comprise ejectors 10:1, 20:1, 30:1 in several or all tanks comprised therein. The system is modifiable, which can be used to provide an efficient system for a specific property, in the most cost-effective way possible.

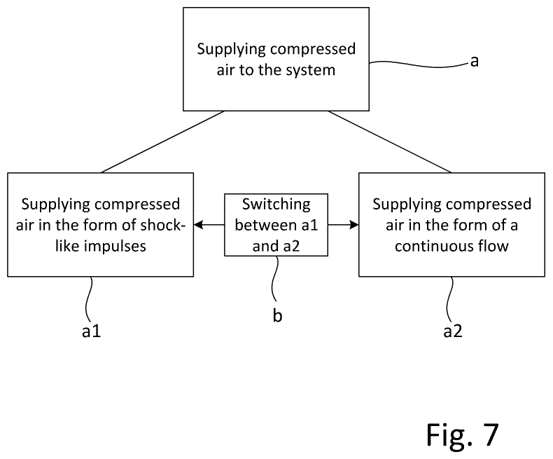

FIG. 7 schematically shows a flow chart for a method for extracting heat from wastewater from a property, the method comprising supplying compressed air to the system.

FIG. 7 shows a flowchart for a method for heat extraction from wastewater which system at least comprises an ejector 10:1, 20:1, 30:1 in at least one tank 10, 20, 30 to prevent sediment formation in at least one tank of the system. In its simplest form, the method only comprises step a): supply of compressed air to at least one tank 10, 20, 30 by means of an ejector 10:1.

Step a) of the method may further comprise a sub-step a1): supply of compressed air in the form of shock-like impulses that are repeated with a predetermined frequency.

Step a) of the method may further include a sub-step a2): supply of compressed air in the form of a continuous flow.

The method may further include a step b) whereby step b) comprises: switching between sub-step a1) and sub-step a2) based on predetermined limits of operating parameters within the system.

The procedure can be run automatically by means of a control system 50 comprised in the system, and/or run manually by means of a user interface 51 comprised in the system, which user interface is wirelessly connected to the control system 50 of the system for heat extraction from wastewater.

1. A system for heat extraction of thermal energy from wastewater from properties, comprising:
at least one pump pit, with a wastewater inlet for wastewater, a pump arranged for pumping wastewater from the pump pit to a pump pit outlet, and a drain opening for discharging wastewater,
at least one buffer tank, arranged in fluid communication with the pump pit outlet,
at least one collector tank arranged in fluid communication with the at least one buffer tank and a drain opening,
a heat exchanger, arranged in the collector tank for moving heat from the collector tank to a heat pump, which heat pump is arranged for accumulation of extracted heat in an accumulator,
wherein at least one of the at least one pump pit, the buffer tank or the collector tank comprises at least one ejector for compressed air arranged therein, which ejector is connected to a compressed air device for controlling the supply of compressed air to at least one of the at least one pump pit, the buffer tank or the collector tank through the at least one ejector, characterized in that the compressed air device further comprises a control system, which control system controls the compressed air device automatically based on operating parameters of the system, and/or manually by means of a user interface comprised in the control system, wherein the compressed air device is configured to supply compressed air to the system in the form of impulses of a flow of said compressed air.

2. The system according to claim 1, wherein the pump pit comprises at least one ejector for compressed air arranged therein.

3. The system according to claim 2, wherein the at least one ejector is arranged at a distance from a bottom of the pump pit, and is directed so that compressed air from the ejector is supplied to the pump pit in a direction away from said bottom.

4. The system according to claim 1, wherein the buffer tank comprises at least one ejector for compressed air arranged therein.

5. The system according to claim 4, wherein at least one ejector is arranged at a bottom of the buffer tank, and is directed so that compressed air from the ejector is supplied to the buffer tank in a direction that corresponds to a flow direction of incoming wastewater through the buffer tank.

6. The system according to claim 1, wherein the collector tank comprises at least one ejector for compressed air arranged therein.

7. The system according to claim 6, wherein at least one ejector is arranged at a bottom of the collector tank, and is directed so that compressed air from the ejector is supplied to the buffer tank in a direction that corresponds to a flow direction of incoming wastewater through the collector tank.

8. The system according to claim 1, wherein each at least one ejector is an open end of a tube.

9. The system according to claim 1, comprising one or several tanks of plastic material.

10. A method for, during heat extraction from wastewater by means of a system according to claim 1, preventing sediment formation in at least one of the pump pit, the collector tank or the buffer tank of the system, wherein the method comprises step:
a) supplying compressed air to at least one tank or pump pit by means of an ejector,
wherein step a) comprises the sub-step:
a1) supplying compressed air in the form of shock-like impulses that are repeated at a predetermined frequency.

11. The method according to claim 10, wherein step a) comprises the sub-step:
a2) supplying compressed air in the form of a continuous flow.

12. The method according to claim 11, wherein the method further comprises step:
b) switching between sub-step a1) and sub-step a2) based on predetermined threshold values of operating parameters within the system.
